(19) United States
(12) Patent Application Publication
(10) Pub. No.: US 2015/0320027 A1
(43) Pub. Date: Nov. 12, 2015

(54) Solar Rechargeable Fishing Float and/or Bobber

(71) Applicant: Clifton George Goodrum, Gunter, TX (US)

(72) Inventor: Clifton George Goodrum, Gunter, TX (US)

(21) Appl. No.: 14/271,929

(22) Filed: May 7, 2014

(51) Int. Cl. A01K 93/02; H02J 7/35

(52) U.S. Cl. CPC A01K 93/02; H02J 7/35

(57) ABSTRACT

A fishing float to provide an indication of a strike from a fish may include a hollow housing having a cavity and a module positioned within the cavity of the hollow housing. The module includes a light and a solar panel to provide power for the light via a rechargeable battery for night fishing and a magnetic or manual waterproof switch to turn the unit on for storage. The fishing float has a continuous energy source therefore there is no need to replace batteries by the user.

### FIELD OF THE INVENTION

The present invention relates to strike indicators, bobbers or floats for fishing. More specifically, the invention relates to indicators or floats that are attached to a fishing line or leader substantially by a friction-fit or interference-fit between the line/leader and the indicator/float and/or by the line/leader being threaded or slid through a circuitous path in the indicator/float. The indicators or floats are lighted by a solar panel battery arrangement.

### BACKGROUND

Fishing floats are common in both lure, live bait, and fly fishing, and many attachment systems are known for attaching the floats to lines and leaders as disclosed in U.S. Pat. No. 7,877,924 incorporated by reference in its entirety in lure or live bait fishing, where total weight of the fishing setup is not so critical, many floats are tied, hooked, or clipped onto fishing lines, for example, using spring-loaded hooks or clips. In fly fishing, where total weight is of great importance, the floats, which act as strike indicators, are often “gripped” onto a leader, using a rubber gripping member or “grommet.” Such a grommet extends all the way through a longitudinal bore in the float and protrudes from each end of the float. Such a grommet is typically an elastic tube, or an elongated, elastic strap with enlarged ends. Typically, the grommet is stretched by the fisherman so that the grommet becomes longer and thinner to provide room for the leader to be slid into the bore by means of a side slot that runs end-to-end on the float. Once the resilient grommet is released by the fisherman, the grommet contracts to its normal length and thickness and, in doing so, expands to fill the bore space and hold the leader inside the float.

A solar panel of the type includes at least one solar energy collecting element intended to receive solar rays is known from prior art. Such a solar panel is used, e.g., for coupling with an engine in order to transform solar energy into electrical or mechanical energy. The solar energy may also be recovered in order to produce electrical energy for heat or cooling, e.g., for a heating or air-conditioning system.

The sport of fishing may be enjoyed either during the daylight hours or during the nighttime hours. During daytime, the float usually can be easily observed in order to determine when the fish have struck the line of the fisherman. However, at dusk and at night, the float may be for all intensive purposes invisible to the fisherman.

Consequently, seeing the float is virtually impossible without some kind of illumination from the float. Illumination with a battery solves the problem temporarily but creates another problem when the power from the battery is insufficient to provide the necessary illumination. The battery may be replaced, but this requires that the float be opened in order to achieve access to the battery. Replacing the battery requires additional expense and may cause the float to leak if a seal is not achieved when the new battery is placed in the float.

### SUMMARY

A fishing float to provide an indication of a strike from a fish may include a hollow housing having a cavity and a module positioned within the cavity of the hollow housing. The module includes a light, battery a solar panel, regulator and an on-off magnetic switch.

The light is a LED light.

The solar panel is connected to a battery.

The module includes a regulator.

The hollow housing may include a tube extending through the hollow housing or not.

The hollow housing includes an upper portion and a lower portion.

The upper portion is transparent or translucent.

The lower portion may be translucent, transparent except where the solar cell must have access to light.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a fishing float module of the present invention;

FIG. 2 illustrates a side view of the fishing float of the present invention;

FIG. 3 illustrates a top view of the fishing float of the present invention;

FIG. 4 illustrates a bottom view of the fishing float of the present invention;

FIG. 5 illustrates a side view of another fishing float of the present invention;

FIG. 6 illustrates a top view of the fishing float of the present invention;

FIG. 7 illustrates a bottom view of the fishing float of the present invention;

FIG. 8 illustrates a side view of another fishing float of the present invention;

FIG. 9 illustrates a top view of the fishing float of the present invention;

FIG. 10 illustrates a bottom view of the fishing float of the present invention;

FIG. 11 illustrates a side view of another fishing float in a first position of the present invention;

FIG. 12 illustrates a side view of the fishing float in a second position of the present invention;

FIG. 13 illustrates a top view of the fishing float of the present invention;

FIG. 14 illustrates a bottom view of the fishing float of the present invention;

FIG. 15 illustrates another fishing float of the present invention;

FIG. 16 illustrates a top view of the fishing float of the present invention;

FIG. 17 illustrates a bottom view of the fishing float of the present invention;

FIG. 18 illustrates a parts layout of the fishing float of the present invention;

FIG. 19 illustrates a cross-sectional view of another fishing float of the present invention;

FIG. 20 illustrates a top view of the fishing float of the present invention;

FIG. 21 illustrates a bottom view of the fishing float of the present invention.

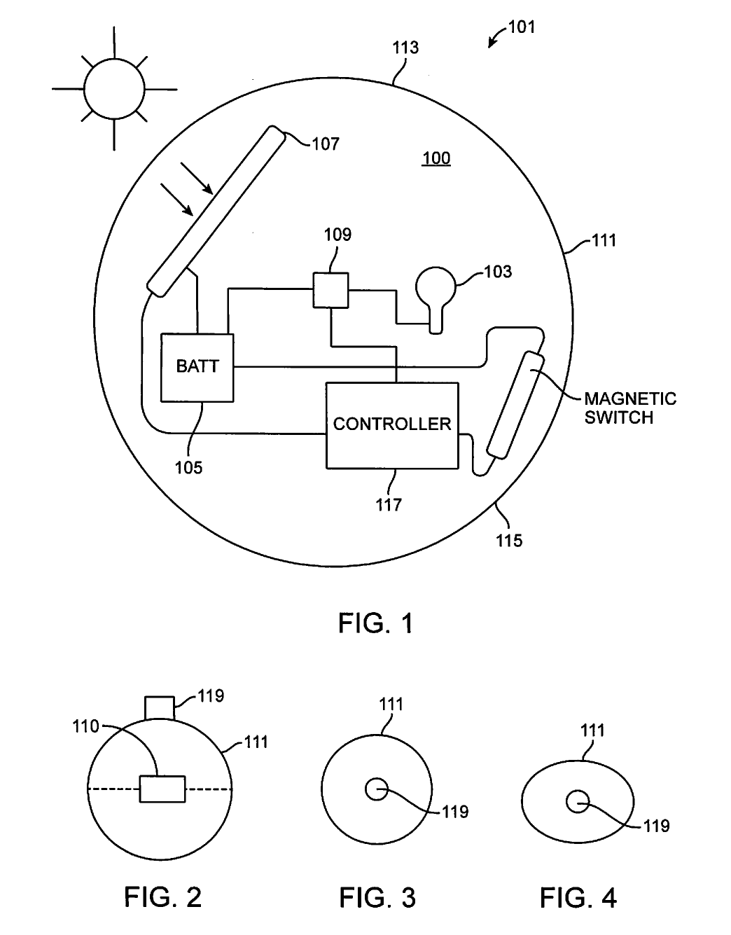

### DETAILED DESCRIPTION

The present invention includes a strike indicator or float 101 which may include a solar powered module 100. The present invention uses solar power energy to activate rechargeable lighting which may be an LED lamp 103 which may be powered by a rechargeable battery 105 which may be connected to a solar panel 107 which may convert solar light or another light source into electrical power to be stored in battery 105, and the present invention does not require battery replacement by the user by virtue of the solar panel 107 replenishing/recharging the electrical power within the battery 105 and may be recharged by solar energy power from the solar panel 107, making it more user-friendly. The power supply and or battery 105 of the present invention allows the light 103 to be activated for a long period of time resulting in easy use by fishermen and more functional for long term use by fishermen. The present invention requires no battery replacement, and the present invention activates a light 103 which may be an LED light 103 or other light from a solar panel 107 using solar power energy and is recharged as long as the solar panel 107 is exposed to sunlight or other sources of light.

The rechargeable solar modular lighted unit/module 100 may include a plastic outer hollow housing 111 which may be transparent or translucent in order to allow the solar energy to enter the modular lighted unit and the housing 111 may include a first portion 113 and a second portion 115 which may be may be connected watertight male and female threads to form a detachable connection or may be permanently connected glue or welding to form a watertight connection to protect the internal electrical parts and associated functions from exposure to the water. The internal light module and battery may be enclosed in a plastic hollow casing, and the LED light may be positioned near the outer periphery of the module. The lighting module may be enclosed by a cylinder shaped casing or an oval shaped casing to protect the internal parts from being exposed to the water. Additionally, the present invention may include a conical reflector to reflect and emit light from the lamp 103 so that the night fishing bobber 100 may be seen easily by the fishermen/user.

The present invention may include a small solar light module 100 and may be enclosed by an external plastic (blown) hollow housing 111 which may be formed from two hemispheres 113, 115 which may be threaded or glued together in order to result in a waterproof casing.

The hollow housing 111 maybe formed from a multitude of substantially flat panels to provide a prism like effect

The user of the present invention may simply recharge the solar lighted night fishing bobber and reuse it over and over again until recharge is required. The process may be continuously repeated. The main attribute of the present invention is that it does not require the purchase or replacement of batteries each time the user fishes at night or uses the bobber. It has a continuous energy supply through the use of solar power technology.

The module 100 may be mounted securely in the inner cavity of the hollow housing 111 and may include a solar panel 107 to collect solar and other types of light energy and convert the light energy to electrical power which may be transmitted and stored in the battery 105 and may be controlled by the regulator 109 and controller 117. The battery 105 may supply electrical power to the light 103 which may be a LED lamp and the electrical power may be controlled by the regulator 109 which may be controlled by the controller 117.

FIG. 2 illustrates a side view of the hollow housing 111 and the module 100, and the hollow housing 111 may have a substantially circular cross-section (round/speaker shape) and may include an attachment arm 119 to attach to fishing line. FIG. 3 and FIG. 4 illustrates the top and bottom view of the hollow housing 111 respectively.

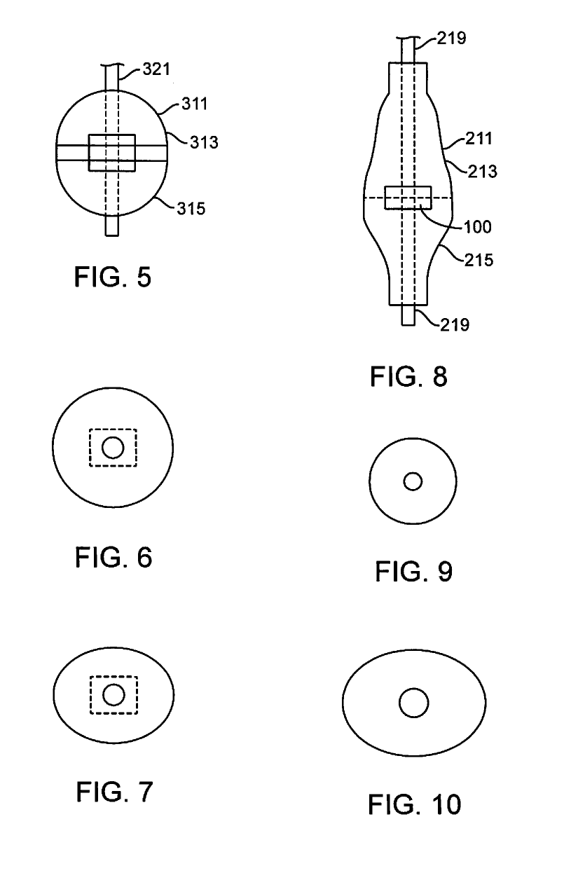

FIG. 5 illustrates a cross-sectional view of another fishing float of the present invention. The hollow housing 311 may be substantially egg shaped having a dome first portion 313 which may be detachably or permanently connected to a second dome portion 315. The first portion 313 and the second portion 315 define a cavity which may support the module 100 as described herein. The hollow housing 311 may include a flexible or rigid tube 321 which may extend completely through the hollow housing 311 and which may be hollow to allow the fishing line to extend through the tube 321.

FIGS. 6 and 7 illustrate the top and bottom view of the hollow housing 311 respectively. FIGS. 6 and 7 illustrate the tube 321 and the module 100.

FIG. 8 illustrates a side view of another hollow housing 211 where the first portion and the second portion may include inclined walls 213, 215 which extend around the periphery of the hollow housing 211. The hollow housing 211 may include a tube 219 having a central axial cavity which extends through the tube to accept fishing line. FIG. 8 additionally illustrates the module 100 of the present invention.

FIGS. 9 and 10 illustrate the top and bottom view of the hollow housing 211 and illustrates the tube 219 and the module 100.

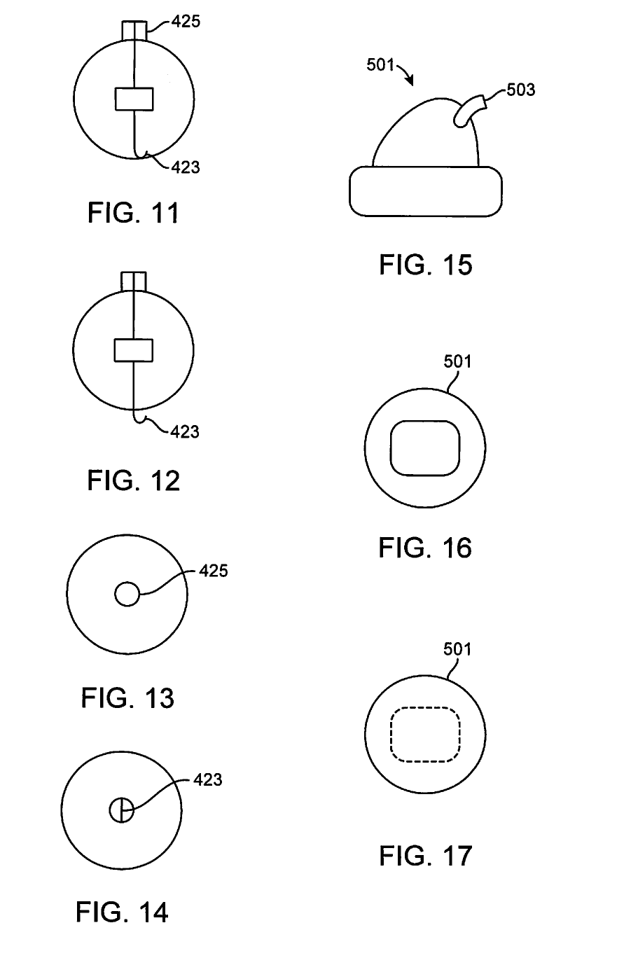

FIGS. 11 and 12 illustrate another hollow housing 411 of the present invention which may be substantially a sphere and may include a button 423 which may extend out of the hollow housing 411. FIG. 11 illustrates the hollow housing 411 in a first position having the fastener for the fishing line which may be a hook or other appropriate fastener 423 withdrawn into the hollow housing 411. FIG. 12 illustrates the hollow housing 411 in the second position having the fastener 423 for the fishing line extending out of the hollow housing 411. The fastener 423 may be controlled by the control button 425 which may be biased to keep the fastener 423 withdrawn without the control button 425 being depressed.

FIG. 13 illustrates a top view of the hollow housing 411 and illustrates the control button 425. FIG. 14 illustrates a bottom view of the hollow housing 411 and illustrates the fastener 423.

The solar rechargeable fishing float 101 may be clear or various colors.

The battery energy drain may be terminated with an on-off switch which may be internal (magnetic) or may be external which may be waterproof. The on-off switch terminates the use of the module 100 and is a power saving switch

The float 100 may be shaped as an oval, oblong, egg, disk (UFO), mushroom or other appropriate shape.

The float 100 may be used as a fisherman's float during nighttime or daytime. The float 100 may be lighted by selected color light emitting diodes (LED) and powered by a rechargeable onboard battery capable of supplying power to the LED for an amount of time and may supply power for an extended number of hours. The battery may be of sufficient capacity, size and type and recharged by an onboard solar cell.

The size and shape of the float 101 may depend on the need and may be approximately 3 inches long and 2 inches in diameter for freshwater and may be cone shaped, egg shaped, cylinder shaped or other conceivable shape having sufficient volume to accommodate the circuitry of the module 100. Salt water variety may be up to 18 inches long by 6″ in diameter.

The float 100 may be attached to the fishing line by metal or plastic ends or by a tube 321 which may extend through the float 100 and which may may be designed to enclose the fishing line.

The battery may be a 1.2 volt, 40 mill amp hour for 3-4 hours using hundred percent charge. Alternatively, the battery may be 10 hour minimum and may be at least 3 times as large for example 120 mahr and may be 150-200 mahr depending on the LED mrl requirements. The salt water variety may require even larger battery capacity for multiple LEDs.

The LED may be selected for color and may be selected having a light output to prolong battery life while supplying adequate light.

The circuit controller may include yx801B prototype mounted with an inductor approximately 0.47 mhy and may be connected with an on off switch device and necessary wires. The prototype electronics may be derived from a 994 solar powered yard light. A separate controller can be designed as needed to provide steady on, flash, flash in sequence, color change (multicolored LED) etc.

The solar cell prototype may be a 1″×1″ solar cell from the yard light, other sizes utilized may be dependent on the size of the physical bobber/float, and the actual solar cell may be of sufficient output to effectively charge selected battery within a reasonable time period of normal daily sunlight.

The material selected may be clear plastic of good resilience, and thick enough, to withstand repeated contact with pointed hard objects during normal deployment while engaged in fishing for example hitting hard rocks or other objects. The clearness may be of sufficient quality to allow non-distorted viewing of the interior and may be a lexan type material.

The float 100 may include an interior surface that is faceted in the upper section and may include a number of reflecting surfaces to distribute the output of the LED in many different directions. The float 100 may include diamond shaped facets. The color of the top portion can be formed from colored material, clear material, transparent plastic either smooth or faceted interior or exterior surface. The lower portion may remain clear to allow solar cell interior to receive direct sunlight or may be lightly colored.

The line attachment tube 321 may be a flexible plastic tube extending through the center top of the float 101 and exits through the center bottom of the float 101. The line attachment to 321 may deviate to bypass the module 100 and the size may be ⅕ to 1/16 inch OD.

Both the top and bottom halves may be joined with appropriate plastic. It may be joined by male and female threads or any other conceivable method to ensure that the item is waterproof. The end of the line attachment tube may be sealed to prevent water from entering the interior cavity of the float 101.

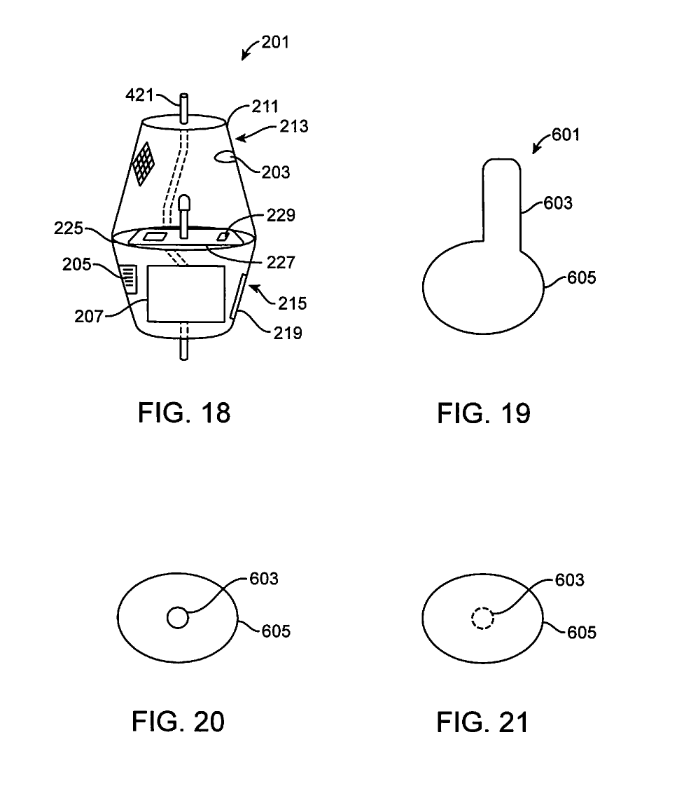

FIG. 18 illustrates a circuit diagram of a float 201 of the present invention which may include a hollow housing 211 which may include a first portion 213 which may be a clear or faceted plastic case top, a second portion 215 which may include a lower cone shaped plastic clear on faceted housing, a power switch 219 which may be manual or magnetic to turn on or turn off the float 201 including the LED, a battery 205 to store power from the solar cell 207 and to activate the LED light 203 which may be white, red, green, yellow and which may be elevated over the glue line 225. The float 201 may include a regulator 229 which may be mounted on a circuit board 227.

FIG. 15 illustrates a float 501 which may be saucer shaped and which may include a switch 503 to activate and deactivate the electrical components of the float 501 which may be a waterproof switch 503.

FIG. 16 illustrates a top view of the float 501 and FIG. 17 illustrates a bottom view of the float 501.

FIG. 19 illustrates a float 601 which may have an extended light tower 603 which extends from the body 605.

FIG. 20 illustrates a top view of the float 601 and FIG. 21 illustrates a bottom view of the float 601.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A fishing float to provide an indication of a strike from a fish, comprising:
a hollow housing having a cavity;
a module positioned within the cavity of the hollow housing;
wherein the module includes a light and a solar panel to recharge a battery that provides power for the light.

2) A fishing float to provide an indication of a strike from a fish as in claim 1, wherein the light is a LED light.

3) A fishing float to provide an indication of a strike from a fish as in claim 1, wherein the solar panel is connected to a battery.

4) A fishing float to provide an indication of a strike from a fish as in claim 1, wherein the module includes a regulator.

5) A fishing float to provide an indication of a strike from a fish as in claim 1, wherein the hollow housing includes a tube extending through the hollow housing.

6) A fishing float to provide an indication of a strike from a fish as in claim 1, wherein the hollow housing includes a first portion (top) and a second portion (bottom).

7) A fishing float to provide an indication of a strike from a fish as in claim 6, wherein the first portion is transparent.

8) A fishing float to provide an indication of a strike from a fish as in claim 6, wherein the first portion is translucent.

9) A fishing float to provide an indication of a strike from a fish as in claim 6, wherein the second portion is transparent.

10) A fishing float to provide an indication of a strike from a fish as in claim 6, wherein the second portion is translucent except for the area over the solar cell.
